(19) United States
(12) Patent Application Publication
(10) Pub. No.: US 2019/0316916 A1
(43) Pub. Date: Oct. 17, 2019

(54) COMPUTER ASSISTED SYSTEM, METHOD AND APPLICATION FOR PROVIDING MULTI-GPS BASED NAVIGATIONAL ASSISTANCE SERVICES

(71) Applicant: RACHEL PERRY, AHOSKIE, NC (US)

(72) Inventor: RACHEL PERRY, AHOSKIE, NC (US)

(21) Appl. No.: 16/308,768

(22) PCT Filed: Dec. 27, 2016
(86) PCT No.: PCT/US16/68675

§ 371 Date: Dec. 10, 2018

(51) Int. Cl. G01C 21/34; G01C 21/36

(52) U.S. Cl. CPC G01C 21/343; G01C 21/3611; G01C 21/3476; G01C 21/3608; G01C 21/3614

(57) ABSTRACT

A computer assisted system for providing navigational assistance services to users includes an electronic communication device capable of running a navigation assistance application and a server in communication with the electronic communication device, over a wireless communication channel, for managing data related to the navigation assistance application. The electronic communication device includes a display means to display a dynamic graphical user interface of the navigation assistance application and to allow the users to schedule navigation services to a number of locations at one instance, a global positioning system module in communication with the navigation assistance application to obtain a real-time location and a processor to process instructions of the navigation assistance application to provide real-time intelligent navigational assistance services to the selected locations. The navigation assistance application processes real-time traffic information and provide an optimal travel plan through the dynamic graphical user interface of the navigation assistance application.

### BACKGROUND OF THE INVENTION

### Field of the Invention

The present invention generally relates to navigation systems. More specifically, the present invention relates to a navigation system for scheduling multiple destinations.

### Background of the Invention

Mobile devices are moving towards having access to larger amounts and varying types of information, either stored on the device itself or accessible to the device over a network. Many map-based applications available today are designed for a variety of different devices such as desktops, laptops, tablet devices, smartphones, handheld global positioning system (GPS) receivers, etc. and for various different purposes such as for navigation, browsing, sports, etc. Most of these applications generate displays of a map based on map data that describes relative locations of streets, highways, points of interest, etc., in the map. Some map-based applications provide a navigation feature, which provides the user with turn-by-turn instructions to a destination, which can be helpful while driving. However, the existing navigation applications designed to run on smart portable devices only allow the users to schedule one navigation map assisted journey at an instance. If the user wants to visit multiple destinations, he/she has to plan the journey and should sequentially enter the destinations one by one once the rides to each destination is completed.

Some other existing map based navigation systems provide various navigating functions and features to the end users, such as vehicle drivers. For example, some navigation systems are able to determine an optimum route to travel by roads between locations in a geographic region. Using input from the end user, the navigation systems can examine various routes between two locations to determine an optimum route to travel from a starting location to a destination location in the geographic region. The navigation system may then provide the end-user with information about the optimum route in the form of instructions that would enable the end user to travel from the starting location to the destination location. The navigation system may be located in an automobile, or in a portable device such as a navigation device or a smartphone and the instructions may take the form of audio instructions or visual maps that are provided as the end user is driving the route. Some navigation system are able to show detailed maps with real-time traffic and other related information on computer displays that outline routes to destinations, directions to be taken at various locations along the routes, locations of certain types of features, and so on.

There are certain prior arts such as US 20110166777 A1 titled “Navigation application” filed by Anand Kumar disclose a mobile navigation device for route guidance. The mobile navigation device combines information related to the route guidance and a digital map display, which is updated to show travel related types of information in an easy to understand user interface. The navigation device includes a navigation application icon which when activated includes a weather indicator icon which, upon activation displays the weather with corresponding symbol icons that describes in picture form the current weather based on current user location, which is automatically updated, or any location that is specified by a user in a search bar located outside the digital map display. However, the above navigation application only allows the user to schedule one navigation map assisted journey at an instance. If the user wants to visit multiple destinations, he/she has to plan the journey and should sequentially enter the destinations one by one once the rides to each destination is completed.

Another prior art US 20140365113 A1, titled “Navigation Application with Several Navigation Modes” filed by Apple Inc. discloses a method for providing navigation instructions on a device. The navigation application differently presents, in different navigation modes, the turn-by-turn navigation instructions and the turn-by-turn map views of a route between a starting location and an ending location. The different navigation modes include the driving mode and the pedestrian mode. As the device traverses a navigated route according to a first mode of transportation, the method displays a first turn-by-turn navigation presentation defined for the first mode. Based on data gathered by the device, the method determines that the device is navigating the route according to a second mode of transportation. The method automatically displays a second, different turn-by-turn navigation presentation defined for the second mode. However, the above navigation application only allows the user to schedule multiple modes of map-assisted journey and would not allow the user to perform journey involving multiple destinations using a single transportation mode such as using a car. According to the above cited method, if the user wants to visit multiple destinations, he/she has to plan the journey and should sequentially enter the destinations one by one once the rides to each destination is completed.

However, all these navigation applications allow the users to schedule only one navigation map assisted journey at a single instance. If the user wants to visit multiple destinations, he/she has to plan the journey and should sequentially enter the destinations one by one once the rides to each destination is completed. Hence there exists a need for an interactive navigation system that would allow the users to schedule multiple navigation map assisted journey at a single instance. The needed interactive navigation system would also provide optimal travel routes to the destinations. Further the needed navigation system would also allow the users to schedule for intermediate planned stops. Moreover the needed navigation system would allow the users to access external applications and in-map attractions through an interactive user interface of the navigation application running on the portable device.

### SUMMARY

In view of the foregoing disadvantages inherent in the known types of systems like in the prior art, the present invention is a computer assisted system providing a variety of navigational assistance services to a number of users. The present computer assisted system includes an electronic communication device capable of running a navigation assistance application, one or more servers in communication with the electronic communication device for managing a variety of data related to the navigation assistance application and a wireless communication channel enabling communication between the electronic communication devices and the server. The navigation assistance application provides real-time intelligent navigational assistance services to a number of locations at a single instance through a dynamic graphical user interface of the navigation assistance application. In addition, the navigation assistance application processes information including real-time traffic information on a number of routes towards the set locations to provide an optimal travel plan to the users through the dynamic graphical user interface of the navigation assistance application.

Accordingly, it is an object of the present invention to provide a navigation assistance application to enable the users to perform multiple navigation location entries at a single instance.

Yet another objective of the present invention is to provide a navigation assistance application capable of identifying an optimal travel plan to multiple locations in a single journey.

It is another objective of the present invention is to provide a navigation assistance application that would allow the users to pre-plan journey to multiple locations with a number of in route stops.

Yet another objective of the present invention is to provide a navigation assistance application that would allow the users to rearrange the locations listed on the dynamic graphical user interface of the navigation assistance application during transit.

Another objective of the present invention is to provide a navigation assistance application that would allow the users to add or delete edit multiple locations on the dynamic graphical user interface in real-time during transit.

Yet another objective of the present invention is to provide a navigation assistance application that would allow the users to receive travel related information including travel time, travel route, traffic related information in real-time during transit.

Another objective of the present invention is to provide a navigation assistance application capable of presenting a variety of local attraction information surrounding the travel routes to the users through the dynamic graphical user interface in real-time during transit.

Yet another objective of the present invention is to provide a navigation assistance application that would allow the users to launch a number of external web links while in use.

Yet another objective of the present invention is to provide a navigation assistance application capable of presenting real-time incidents view, real-time roadblock related information and real-time people and animal crossing information to the users through the dynamic graphical user interface in real-time during transit.

Another objective of the present invention is to provide a navigation assistance application that would allow the users to download and play a variety of games during transit.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness. The invention will be described and explained with additional specificity and detail through the use of the accompanying drawing in which:

FIG. 1 illustrates a block diagram showing the present computer assisted system for providing navigational assistance services to users, according to a preferred embodiment of the present disclosure;

FIG. 2 is a block diagram showing the different components and modules of the electronic communication device running the navigation assistance application, according to a preferred embodiment of the present invention;

FIG. 3 is a block diagram showing the different components and modules of the server in communication with the electronic communication device and running the server side version of the navigation assistance application, according to a preferred embodiment of the present invention;

FIG. 4 represents a registration or login page of the navigation assistance application, according to an embodiment of the present disclosure;

FIG. 5 represents a dynamic graphical user interface of the navigation assistance application running on the electronic communication device, according to an embodiment of the present disclosure; and

FIG. 6 represents a dynamic graphical user interface of the navigation assistance application running on the electronic communication device to allow the users to schedule navigation services to a number of locations at one instance, according to an embodiment of the present disclosure.

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention. The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The following embodiments and the accompanying drawings, which are incorporated into and form part of this disclosure, illustrate one or more embodiment of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

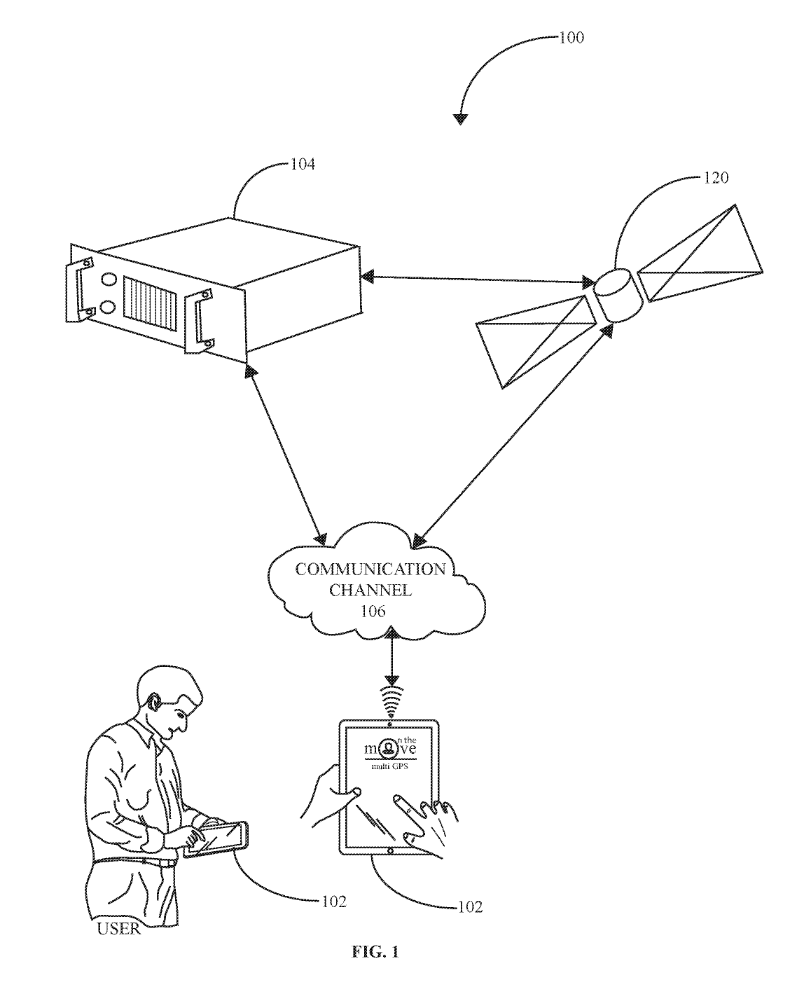

The present disclosure relates to a system and method for providing a variety of navigational assistance services to a number of users using a navigation assistance application. The present system provides turn-by-turn navigation assistance to the users through a graphical user interface of the navigation assistance application. FIG. 1 illustrates a block diagram showing the present computer assisted system 100 capable of providing the navigational assistance services to users, according to a preferred embodiment of the present disclosure. The present computer assisted system 100 for providing navigational assistance services to users includes an electronic communication device 102 capable of running a navigation assistance application, one or more servers 104 in communication with the electronic communication device 102 for managing a variety of data related to the navigation assistance application and a wireless communication channel 106 for enabling communication between the electronic communication devices 102 and the server 104, thereby enabling data transfer between the navigation assistance application running on the electronic communication devices 102 and the server 104 as shown in FIG. 1. The wireless communication channel 106 enables real-time communication between the navigation assistance application running on the electronic communication devices 102 and the server 104 for providing turn-by-turn navigation assistance to the users through a dynamic graphical user interface of the navigation assistance application. The server 104 communicates with a satellite 120 for location mapping and navigation in real-time or at scheduled intervals to update a variety of data including mapping data and other location mapping and guidance related data associated with the server 104. The updated data is reflected on the map data and other data presented to the user through the dynamic graphical user interface of the navigation assistance application. The present navigation assistance application running on the electronic communication devices 102 allows the users to set a number of locations or destinations to travel through the dynamic graphical user interface of the navigation assistance application in one instance or through a single window of the dynamic graphical user interface. The present navigation assistance application running on the electronic communication devices 102 processes a variety of information including real-time traffic information of a number of routes towards the locations or destinations and provides an optimal travel plan to the users through the dynamic graphical user interface of the navigation assistance application. The navigation assistance application suggest the optimal travel plan by automatically rearranging the locations provided by the user. The navigation assistance application automatically suggest a next closest location from the list of locations listed on the dynamic graphical user interface of the navigation assistance application based on factors such as, real-time traffic information, proximity to other scheduled stops of the user, etc.

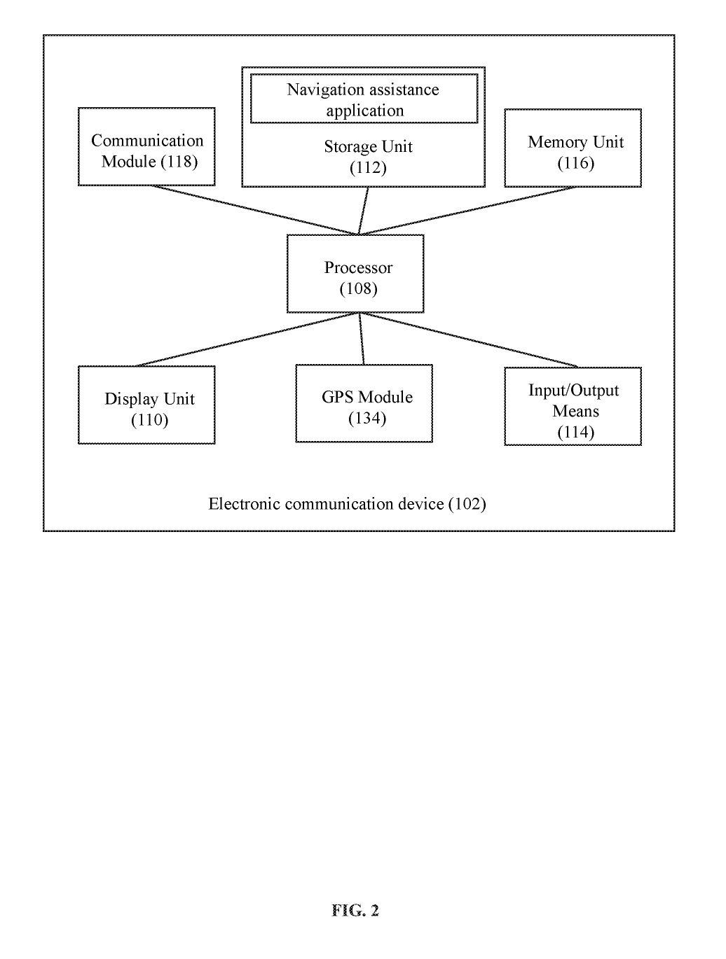

FIG. 2 is a block diagram showing the different components and modules of the electronic communication device 102 running the navigation assistance application, according to a preferred embodiment of the present invention. The electronic communication device 102 can be smart devices such as, but not limited to, a smartphone, tablet, computer, smart wearable devices, and other smart devices connected to the Internet and capable of displaying the dynamic graphical user interface (GUI) of the navigation assistance application. The electronic communication device 102 includes a processor 108 to process a number of instructions of the navigation assistance application, a display means 110 for displaying the dynamic graphical user interface of the navigation assistance application, a storage unit 112 for storing a variety of data including real-time map related contents shared or received through the navigation assistance application, an input/output means 114 for allowing the users to interact with the dynamic graphical user interface of the navigation assistance application, a memory unit 116 for temporarily storing the data and instructions of the navigation assistance application while performing a number of operations by the processor 108 based on the instructions of the navigation assistance application and a communication module 118 to enable communication between the electronic communication devices 102 and the server 104 via the communication channel 106. The electronic communication device further includes a global positioning system (GPS) module 134 to obtain a real-time location of the device 102 and communicates the location information with the sever 104. The users are allowed to interact with the contents of the navigation assistance application through the dynamic graphical user interface using the input/output means 114. The users are allowed to interact with the contents presented on the dynamic graphical user interface of the navigation assistance application using a keyboard, pointing device such as a mouse, at least one gesture or touch, voice activation, or any other interacting means. In some instance, the electronic communication devices 102 further includes a camera module to capture the contents including images and videos and share the captured contents through the dynamic graphical user interface of the navigation assistance application. Further, the input/output means 114 allows the users to respond or react to the contents presented through the dynamic graphical user interface of the navigation assistance application using text, voice i.e. as audio response or audio comments, pictures, videos or special characters such as, but not limited to, emojis and other symbols. Further the input/output means 114 allows the users to view or listen to the reactions or responses from other users on the contents presented through the dynamic graphical user interface of the navigation assistance application.

A user can launch the navigation assistance application from their electronic communication device 102 such as a smartphone. The processor 108 of electronic communication device 102 executes the instructions of the navigation assistance application to provide real-time intelligent navigational assistance services to the one or more locations or the destinations selected by the user. The display means 110 displays the dynamic graphical user interface of the navigation assistance application and presents the users with real-time dynamic contents to allow the users to schedule navigation services to multiple locations at one instance. In some embodiment, the display means 110 is a touchscreen display and allows the users to interact with the contents presented through the dynamic graphical user interface of the navigation assistance application. The navigation assistance application communicates with the server 104 in real-time and processes a variety of information including real-time traffic information of one or more routes towards the user selected locations or destinations and presents an optimal travel plan to the users through the dynamic graphical user interface of the navigation assistance application.

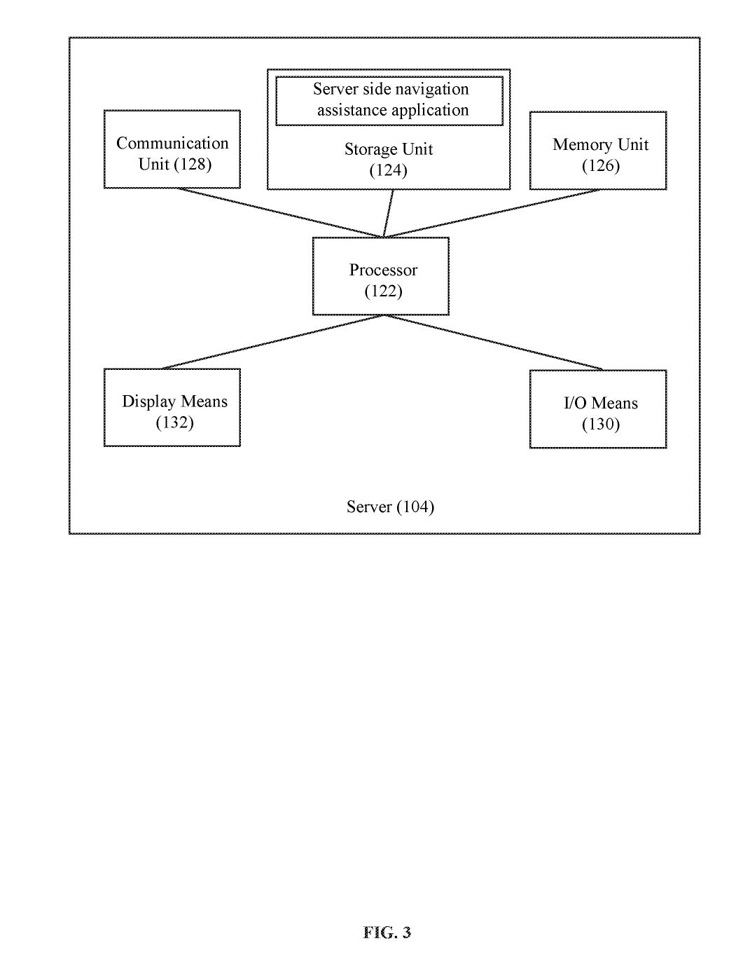

FIG. 3 is a block diagram showing the different components and modules of the server 104 in communication with the electronic communication device 102 and running the server side version of the navigation assistance application, according to a preferred embodiment of the present invention. According to a preferred embodiment of the present computer assisted system 100, all the communication between the navigation assistance application running on the electronic communication devices 102 of the users and the server 104 are performed over the wireless communication channel 106, which includes wireless services offering Internet. The server 104 can be a physical server 104 located at one or more locations or a central cloud server 104 offering navigational and other associated services to the users via the navigation assistance application running on the electronic communication devices 102 and connected to the central cloud server 104. The server 104 includes similar components as any normal server or a computer, which includes a processor 122, a storage unit 124, a memory unit 126, a communication unit 128, an input/output (I/O) means 130 and an optional display means 132. The server 104 is in communication with the electronic communication devices 102 in real-time over the Internet enabled by the communication unit 128. In some instances, the server 104 is installed with a server side navigation assistance application configured to manage the operations of the navigation assistance application running on the electronic communication devices 102. The server side navigation assistance application is stored in the storage unit 124 and the processor 122, when required, executes the instructions of the navigation assistance application to manage the user information and a variety of other information related to the navigation routes and associated services and attractions around the travel route. The memory unit 126 stores the data associated with the server side navigation assistance application when the processor 122 executes the instructions of the application. The server side navigation assistance application includes a user management module that handles all the information related to the user registration and all other user related activities performed by the users through the navigation assistance application running on their electronic communication devices 102. The server side navigation assistance application running on the server 104 further includes a content management module that receives and temporarily or permanently stores the contents to be presented through the dynamic graphical user interface of the navigation assistance application running on the electronic communication devices 102. The content management module manages the contents and the responses or reactions on each of the contents provided by the users through the navigation assistance application running on the electronic communication devices 102.

The users can download the navigation assistance application from Internet sources including, but not limited to, iTunes store or App store, Google play store and many other software stores and install the application in their electronic communication devices 102 such as Smartphones. In some instance, different versions of the navigation assistance application are available from the Internet sources, each version is configured to optimally run on different electronic communication devices 102 such as tablet, smartphone, smart wearable device etc., and the users can select and download the desired versions of the navigation assistance application into their electronic communication device 102. After downloading and installing the navigation assistance application, the users can launch the application from the electronic communication device 102 and view the dynamic graphical user interface, which allows the users to perform a number of tasks such as, requesting navigational assistance services to multiple destinations or locations at one instance.

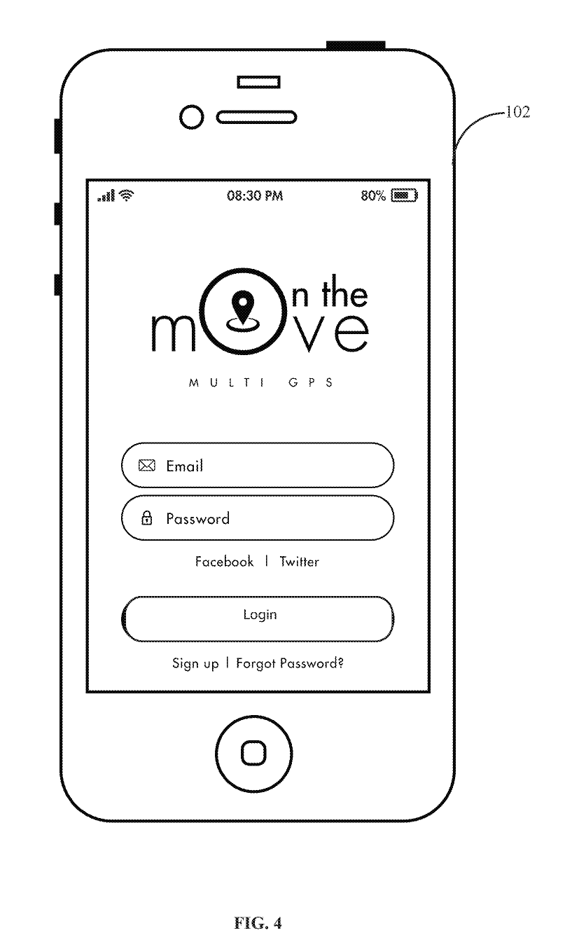

FIG. 4 represents a welcome page or registration or login page of the navigation assistance application running on the electronic communication device 102, according to an embodiment of the present disclosure. The registration or login page of the navigation assistance application prompts the new users to register into the application. The registration or sign up page of the navigation assistance application prompts the users to enter their personal details, such as, name, age, preferences, etc. and also allows the user to upload one or more profile pictures. Once the user completes the registration, he/she will be provided a unique username and password or allowed to select a desired username and password for logging into the navigation assistance application. In some instances, the present navigation assistance application is associated with other social media applications such as, but not limited to, Facebook, Google, twitter, etc., and is configured to access the user details from the social media applications in order to login to the navigation assistance application.

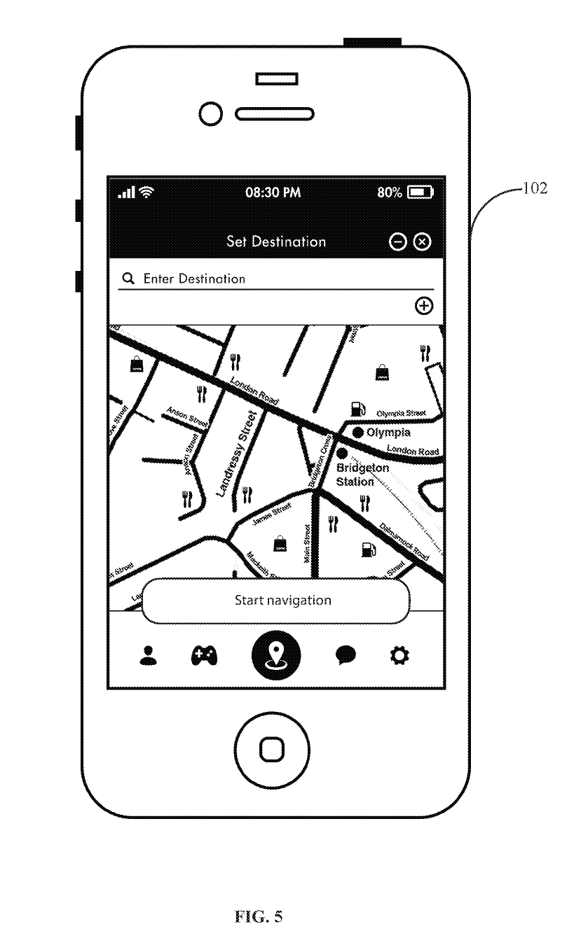

FIG. 5 represents the dynamic graphical user interface of the navigation assistance application running on the electronic communication device 102, showing the dynamic map interface, according to an embodiment of the present disclosure. The navigation assistance application is configured to communicate with the global positioning system (GPS) module 134 of the electronic communication device 102. The navigation assistance application automatically recognizes the real-time location of the user using the information received from the server 104 and the global positioning system (GPS) module 134 of the electronic communication device 102. The navigation assistance application allows the users to select from the options provided on the dynamic graphical user interface of the navigation assistance application to automatically determine the real-time location of the user. In addition, the dynamic graphical user interface of the navigation assistance application also includes provisions for allowing the user to manually enter the location of the user or a desired location from which he/she has to reach multiple locations or destinations. The dynamic graphical user interface of the navigation assistance application running on the electronic communication device 102 provides a number of map views including street view, satellite view and real-time three dimensional view of the locations including real-time traffic and other related information. The map views includes labels and interactive icons for important locations and places of importance, such as gas stations, vehicle maintenance locations, restaurants, hotels, tourist attractions, shopping centers, etc., as shown in FIG. 5. The touchscreen display or the display means 110 of the electronic communication device 102 allows the users to interact with the map views and the labels and interactive icons presented through the dynamic graphical user interface of the navigation assistance application. The users can tap anywhere on the map views, select the icons, and other symbols and user interactive notifications presented through the dynamic graphical user interface of the navigation assistance application. In some instances, the navigation assistance application provides real-time notification for a number of events present at a particular route travelled by the user. The events presented through the dynamic graphical user interface of the navigation assistance application includes accident alerts, vehicle stops alerts, roadblock alerts, traffic alerts, weather condition alerts, animal crossing alerts, police awareness, pedestrial crossings, traffic lights, etc. The notifications for the events are presented in form of pop up windows on the dynamic graphical user interface of the navigation assistance application. In some other instance, the navigation assistance application provides audio alerts for each of the events identified during the travel along the selected route.

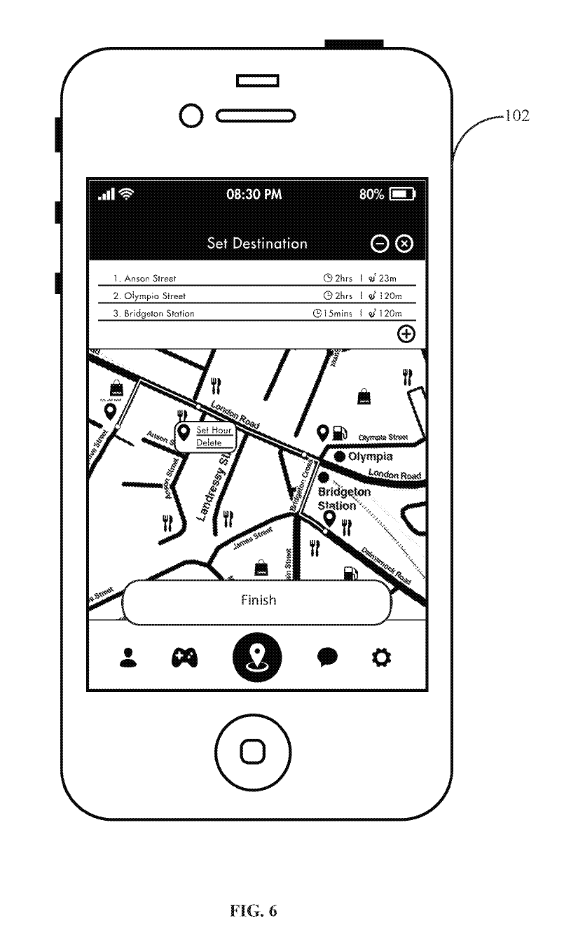

FIG. 6 represents the dynamic graphical user interface of the navigation assistance application running on the electronic communication device 102 to allow the users to schedule navigation services to a number of locations or destinations at one instance, according to an embodiment of the present disclosure. The display means 110 of the electronic communication device 102 displays the dynamic graphical user interface of the navigation assistance application, which includes options to allow the users to schedule navigation services to a number of locations or destinations at one instance. The users can enter the desired locations or destinations, one by one, through the dynamic graphical user interface of the navigation assistance application as shown in FIG. 6. The users are allowed to enter their desired locations or destinations in any order through the dynamic graphical user interface and once the user enters all the locations or destinations, he/she can instruct the navigation assistance application to show the travel route information for each location or destination and the estimated time for reaching all the locations. In case of a multiple location or multiple destination travel plan, as in FIG. 6, the navigation assistance application calculates the time taken for reaching each location based on the real-time travel condition information obtained from the server 104 over the wireless communication channel 106.

In an embodiment, the navigation assistance application first calculates the time for reaching the first location entered through the dynamic graphical user interface of the navigation assistance application based on the real-time travel condition. The time for reaching the second location entered through the dynamic graphical user interface of the navigation assistance application is calculated from the first location and so on. However, the navigation assistance application includes an intelligent logic to automatically identify an optimal travel plan involving all the entered locations or destinations by the users. The users can opt to view the optimal travel plan, which involves, automatic analysis of the travel routes and time taken for each travel and the real-time, historical and proposed travel conditions, to each of the locations or destinations selected by the user through the dynamic graphical user interface of the navigation assistance application. The optimal travel plan may involve the automatic rearrangement of the selected locations or destinations through the dynamic graphical user interface of the navigation assistance application to save time based on the real-time historical and proposed travel conditions.

In a preferred embodiment, the navigation assistance application allows the users to manually rearrange the locations or destinations selected by the user, at any point of time during the travel, through the dynamic graphical user interface of the navigation assistance application. The dynamic graphical user interface of the navigation assistance application allows the users to drag and rearrange the order of the already entered locations or destinations at any point of time during the travel through the touchscreen display or the display means 110. In some instances, the dynamic graphical user interface of the navigation assistance application allows the users to cancel any number of already entered locations or destinations at any point of time during the travel through the touchscreen display or the display means 110. In some other instances, the dynamic graphical user interface of the navigation assistance application allows the users to add any number of new entered locations or destinations at any point of time during the travel through the touchscreen display or the display means 110. Then the intelligent logic of the navigation assistance application processes the changes made to the locations or destinations in real-time to provide another optimal travel plan to the user through the dynamic graphical user interface. Further the navigation assistance application allows the users to set scheduled intervals through the dynamic graphical user interface during the travel to the selected locations. The navigation assistance application guides the users to the selected locations and after the scheduled interval, the application resumes the turn-by-turn map navigation to the other selected locations.

The present method for providing navigational services to multiple locations includes the steps of launching the navigation assistance application from within the electronic communication device 102 and registering or logging into the navigation assistance application using the credentials provided to the user. The users can then enter one or more location details for receiving dynamic turn-by-turn map directions through the dynamic graphical user interface of the navigation assistance application. The users can also rearrange or edit the locations listed on the dynamic graphical user interface at any point of time, before or after starting the journey to the selected destinations. Then the users can schedule one or more stops during the travel to the selected locations through the dynamic graphical user interface of the navigation assistance application. Further, the uses can view a variety of travel related information including travel time, travel route, traffic related information associated with each of the locations listed on the dynamic graphical user interface in real-time.

In an embodiment, the present navigation assistance application allows the users to provide a number of inputs in form of voice instructions and using touch or gestures on the touchscreen display means 110 of the electronic communication device 102. Further the navigation assistance application running on the electronic communication device 102 alerts the user using audio and through the dynamic graphical user interface in form of pop-up windows on the dynamic graphical user interface. The navigation assistance application running on the electronic communication device 102 also provides local attraction information surrounding the routes towards the selected locations or destinations by the users through the dynamic graphical user interface of the navigation assistance application. In some instance, the local attraction information is provided to the users through the dynamic graphical user interface in form of interactive icons. The users can access the interactive icons from within the dynamic graphical user interface of the navigation assistance application to launch a number of external web links. For example, the navigation assistance application can show nearby restaurants, ratings for each place, link to website of each place, etc. The server side navigation assistance application running on the server 104 provides scheduled updates to the navigation assistance application running on the electronic communication devices 102. The users can download the scheduled updates received through the wireless communication channel for a preset amount. Further the navigation assistance application running on the electronic communication device 102 allows the users to access a number of other applications such as, but not limited to, web browsers, social media applications etc. during travel. Further the navigation assistance application running on the electronic communication device 102 allows the users to download and play a number of games during travel. Further, the navigation assistance application running on the electronic communication device 102 allows the users to access a number of applications associated with the navigation assistance application during travel. The applications includes a web browser to allow the users to access Internet, a multimedia player to play multimedia files including audio, video and images, etc. In some instances, the navigation assistance application running on the electronic communication device 102 allows the fellow users or passengers to download and play games, such as, online and offline games, during travel. The navigation assistance application running on the electronic communication device 102 is intelligent to detect the driver and passenger and only allows the passengers to use the external applications and games during the travel.

Further, it should be noted that the steps described in the method of use can be carried out in many different orders according to user preference. The use of “step of” should not be interpreted as “step for”, in the claims herein and is not intended to invoke the provisions of 35 U.S.C. § 112, (6). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. A computer assisted system for providing a plurality of navigational assistance services to a plurality of users comprising:
a) an electronic communication device capable of running a navigation assistance application,
wherein the electronic communication device includes:
i.) a processor to process a plurality of instructions of the navigation assistance application to provide real-time intelligent navigational assistance services to a plurality of locations;
ii.) a global positioning system (GPS) module in communication with the navigation assistance application to obtain a real-time location of the electronic communication device;
iii.) a display means to display a dynamic graphical user interface of the navigation assistance application to allow the users to schedule navigation services to the plurality of locations at one instance; and
iv.) a storage means to store the navigation assistance application;
b) at least one server in communication with the electronic communication device for managing a plurality of data related to the navigation assistance application; and
c) a wireless communication channel for enabling communication between the electronic communication devices and the server;
characterized in that the navigation assistance application processes a plurality of information including real-time traffic information of a plurality of routes towards the plurality of locations to provide an optimal travel plan to the users through the dynamic graphical user interface of the navigation assistance application.

2. The computer assisted system of claim 1, wherein the navigation assistance application suggest the optimal travel plan by automatically rearranging the plurality of locations provided by the user,
wherein the navigation assistance application automatically suggest a next closest location from the plurality of locations listed on the dynamic graphical user interface of the navigation assistance application.

3. The computer assisted system of claim 1, wherein the electronic communication device is selected from a group consisting of smartphones, tablets, smart wearable devices, computers, and other smart devices capable of running the navigation assistance application.

4. The computer assisted system of claim 1, wherein the processor processes the plurality of instructions of the navigation assistance application to:
I) allow the users to enter the plurality of locations through the dynamic graphical user interface;
II) rearrange the plurality of locations listed on the dynamic graphical user interface;
III) edit the plurality of locations listed on the dynamic graphical user interface in real-time during transit;
IV) preset a plurality of stops during travel to the plurality of locations; and
V) view a plurality of travel related information including travel time, travel route, traffic related information associated with each of the plurality of locations listed on the dynamic graphical user interface in real-time.

5. The computer assisted system of claim 1, wherein the electronic communication device running the navigation assistance application allows the users to provide a plurality of inputs in form of voice instructions.

6. The computer assisted system of claim 1, wherein the electronic communication device running the navigation assistance application allows the users to provide the inputs using a plurality of gestures on the display means, the display means being a touchscreen display.

7. The computer assisted system of claim 1, wherein the electronic communication device running the navigation assistance application allows the users to provide the inputs through an input device selected from a group consisting of keyboards, touchpads and other electronic input devices.

8. The computer assisted system of claim 1, wherein the navigation assistance application running on the electronic communication device alerts the user using audio and through the dynamic graphical user interface.

9. The computer assisted system of claim 1, wherein the navigation assistance application running on the electronic communication device provides a plurality of local attraction information surrounding the plurality of routes to the users through the dynamic graphical user interface.

10. The computer assisted system of claim 9, wherein the plurality of local attraction information is provided to the users through the dynamic graphical user interface in form of interactive icons,
wherein the users can access the interactive icons from within the dynamic graphical user interface of the navigation assistance application to launch a plurality of external web links.

11. The computer assisted system of claim 1, wherein the server includes a server side navigation assistance application in communication with the navigation assistance application running on the electronic communication device to provide the plurality of navigational assistance services to the users.

12. The computer assisted system of claim 1, wherein the server side navigation assistance application provides a plurality of scheduled updates to the navigation assistance application running on the electronic communication device,
wherein the users can download the scheduled updates received through the wireless communication channel for a preset amount.

13. The computer assisted system of claim 1, wherein the dynamic graphical user interface of the navigation assistance application running on the electronic communication device provides a plurality of map views including street view and satellite view,
wherein the map views displayed on the dynamic graphical user interface provides a plurality of real-time incidents view, a plurality of real-time roadblock related information and a plurality of real-time people and animal crossing information.

14. The computer assisted system of claim 1, wherein the navigation assistance application running on the electronic communication device allows the plurality of users to access a plurality of applications during travel,
wherein the plurality of applications includes a web browser to allow the users to access internet and a multimedia player to play multimedia files including audio, video and images.

15. The computer assisted system of claim 1, wherein the navigation assistance application running on the electronic communication device allows the plurality of users to download and play a plurality of games during travel.

16. A computer readable storage means having embodied thereon a navigation assistance application, the navigation assistance application being executable by a processor to perform a method for providing a plurality of navigational assistance services to a plurality of users, the method comprising:
a) launching the navigation assistance application in an electronic communication device;
b) establishing communication between the navigation assistance application and a server running a server side navigational assistance application over a wireless communication channel;
c) allowing the users to enter at least one location through a dynamic graphical user interface of the navigation assistance application; and
d) viewing a dynamic map view to the locations listed on the dynamic graphical user interface of the navigation assistance application,
a. wherein the navigation assistance application analyzes a plurality of routes towards the locations to provide an optimal travel plan to the users through the dynamic graphical user interface of the navigation assistance application.

17. The computer readable storage means of claim 16, wherein the navigation assistance application analyzes the plurality of routes towards the locations based on a plurality of information including real-time traffic information and the coordinates of each of the locations.

18. The computer readable storage means of claim 16, wherein the navigation assistance application suggest the optimal travel plan by automatically rearranging the locations provided by the user,
wherein the navigation assistance application automatically suggest a next closest location from the locations listed on the dynamic graphical user interface of the navigation assistance application.

19. The computer readable storage means of claim 16, wherein the navigation assistance application allows the users to preset a plurality of stops and time to spend at each of the stops.

20. The computer readable storage means of claim 16, wherein the navigation assistance application allows the users to rearrange the locations listed on the dynamic graphical user interface of the navigation assistance application.
